(19) United States
(12) Patent Application Publication
(10) Pub. No.: US 2018/0361417 A1
(43) Pub. Date: Dec. 20, 2018

(54) SPIKE-TRIPOD KIT FOR PAINTING AUTO PARTS AND METHOD OF USE

(71) Applicant: JOSE MANUEL ALAYON, HOLLYWOOD, FL (US)

(72) Inventor: JOSE MANUEL ALAYON, HOLLYWOOD, FL (US)

(21) Appl. No.: 15/627,441

(22) Filed: Jun. 19, 2017

(51) Int. Cl. B05B 13/02; F16M 11/04; F16M 11/24

(52) U.S. Cl. CPC B05B 13/0285; F16M 11/24; F16M 11/04

(57) ABSTRACT

a spike-tripod kit that is used to secure and paint aftermarket auto parts that define apertures within the auto parts. The spike tripod kit comprises of a plurality of tripods that define a spike on the apex of each tripod. the spike tripod kit may also comprise of a plurality of leg extensions that attach to each leg of each tripod. The extensions are used to raise the tripods upward when painting larger auto parts. The kit can be made of a metal. The design of each tripod of the kit allows the kit to be stored in small spaces. For, the tripods of the kit can be stacked upon one another. The kit is used by placing the spike of each spike-tripod within an existing aperture of an aftermarket auto part. Each existing aperture is pre-designed to secure to another existing auto part when placed on a vehicle. Most auto parts painted will require at least two spike-tripods to secure them in a position that will allow the auto part to be painted.

### BACKGROUND

The present invention is directed to a spike-tripod kit that is used to paint auto panels and parts.

The inventor of the present invention is a paint technician that specializes in painting after marked auto parts.

One of the greatest difficulties he experienced painting aftermarket parts is that he could not paint the whole piece without having to move the piece from one angle to the other. Having to move the pieces from one angle to another slowed the process of painting each piece, for he had to wait for pieces to dry before manipulating the pieces to a second and a third position.

After studying the aftermarket auto parts, he realized that most aftermarket parts defined at least two apertures that were used to connect the parts to existing parts of vehicles.

He reasoned that the apertures could be used to secure the parts on holding structures that would allow him to paint the aftermarket parts without having to move the pieces from the first position to a subsequent position.

He first thought that hooking the pieces on existing ceiling lines would allow him to paint the after-market parts. In practice, he realized that the design was faulty, for the lines would leave areas of the aftermarket parts smudged. In addition, often the aftermarket parts would accidently move while being painted, thereby creating blemishes on the painted surfaces.

He realized that he had to device a system or kit that would allow him to secure the aftermarket parts in place while not obstructing the surface of the parts being painted.

In his initial design, he placed a spike on a plurality of four-legged support structures. He placed the four-legged support structures in positions that coincided with the apertures of the aftermarket parts so that the parts would be raised to positions that would allow all surface areas of the parts to be painted without having to manipulate the parts from a first position to a second position.

The four-legged support structures had a deficiency, if each structure was not on a flat surface, the structures tended to wobble while painting, thereby causing inferior paint jobs.

The inventor then realized he had to design a support structure that would not in-advertently move while painting. He realized that a three-legged support structure was the design needed to ensure that the support structure would not move from side to side. A three-legged support structure only has three points of contact with an existing surface, thereby eliminating the wobble that could occur with a four-legged support structure when placed on an uneven surface.

For the foregoing reasons, there is a need for a spike-tripod kit that can be used to secure aftermarket parts when painting.

### SUMMARY

The present invention is a spike-tripod kit that is used to secure and paint aftermarket auto parts that define apertures within the auto parts.

The spike tripod kit comprises of a plurality of tripods that define a spike on the apex of each tripod.

In an embodiment of the present invention, the kit further comprises of a plurality of leg extensions that attach to each leg of each tripod. The extensions are used to raise the tripods upward when painting larger auto parts.

The present invention can be made of many materials, yet in a preferred embodiment, it will be made of a metal. The spike of each tripod will be at least 2 inches in length.

The design of each tripod of the present invention, allows the kit to be stored in small spaces. For, the tripods of the kit can be stacked upon one another.

The kit is used by placing the spike of each spike-tripod within an existing aperture of an aftermarket auto part. Each existing aperture is pre-designed to secure to another existing auto part when placed on a vehicle. Most auto parts painted will require at least two spike-tripods to secure them in a position that will allow the auto part to be painted.

An object of the present invention is to provide a spike-tripod kit that will allow a paint technician to paint an aftermarket part without having to manipulate it from one location to another.

Another object of the present invention is to provide a spike-tripod kit that will not move when painting an aftermarket part.

Yet another object of the present invention is to provide a spike tripod-kit that will reduce the time need to paint aftermarket auto parts.

Still a further object of the present invention is to provide a spike-tripod kit that can be stored in a small space.

Yet still a further object of the present invention is to provide a spike-tripod kit that can be used to paint auto parts having different dimensions.

Yet still another object of the present invention is to provide a spike-tripod kit that will minimize the chances of inadvertently contaminating the surface of an auto part being painted.

### DRAWINGS

These and other features, aspects, and advantages of the present invention will become better understood with regards to the following description, appended claims, and drawings where:

FIG. 1 is a perspective view of an embodiment of the present invention;

FIG. 2 is a perspective view of a second embodiment of the present invention;

FIG. 3 is a perspective view of a leg extension used with the embodiments of the present invention;

FIG. 4 is a perspective view of the present invention showing how an automobile door panel would be secured using a plurality of spike-tripods: the spike of each spike-tripod is inserted within the existing apertures of the door panel;

FIG. 5 is an exploded view showing the spike of each spike-tripod inserted with the aperture of each door panel.

### DESCRIPTION

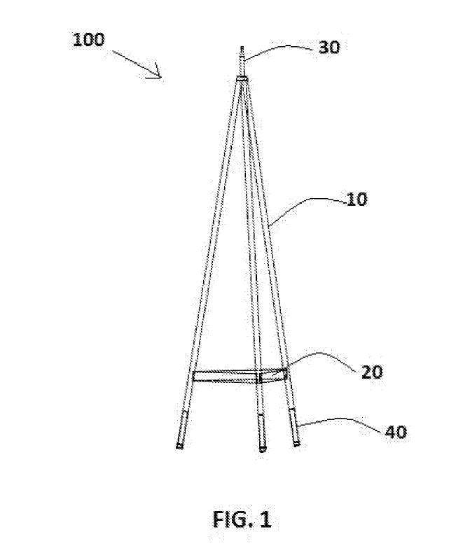

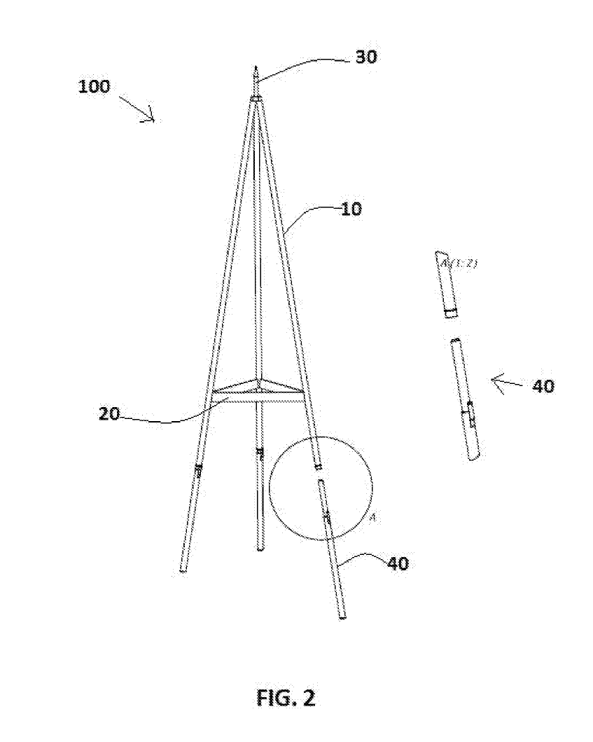

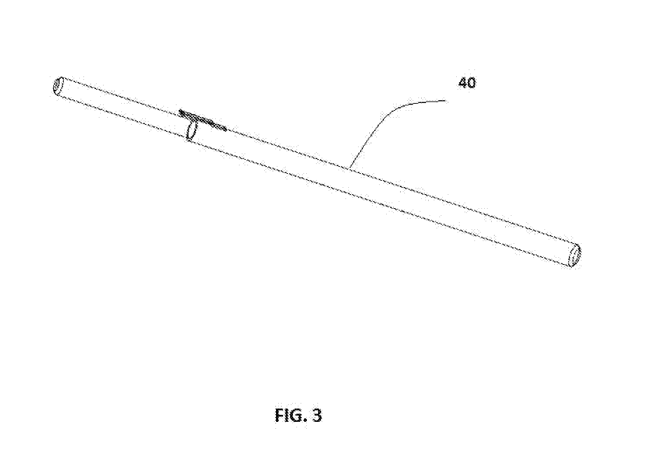

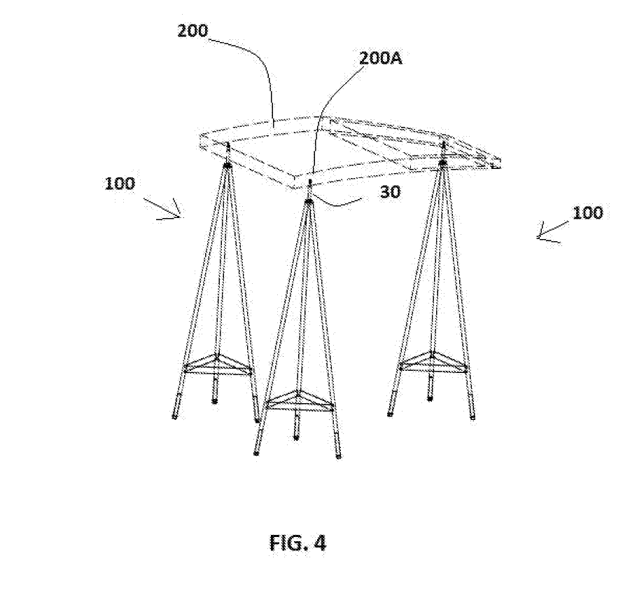

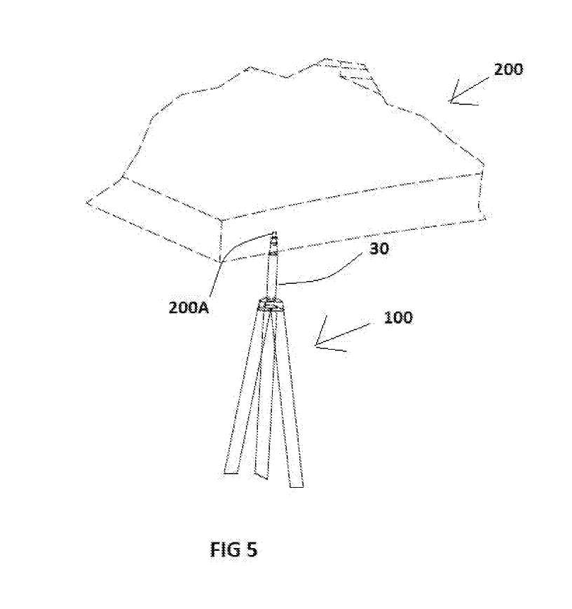

As seen in FIGS. 1-5, the present invention is a spike-tripod kit used to support auto parts that are to be painted. The spike-tripod kit is used to paint auto parts that define at least one aperture. The spike-tripod kit 100 comprises at least one tripod 10, each tripod 10 defines a stabilizer 20 and an apex point 10a and at least one spike 30. Each spike 30 attaches to each apex point 10a.

In an embodiment of the present invention, the spike-tripod kit 100 comprises of a plurality of leg extensions 40, each leg extension 40 attaches to each leg of each tripod 10. Each leg extension 40 can be from about 1 foot to about 3 feet in length. It is foreseeable that the leg extensions 40 could be longer in length.

In a preferred embodiment, the spike-tripod kit 100 is made of metal.

In a preferred embodiment, each spike 30 of the spike-tripod kit 100 measures at least 2.5 inches.

The spike-tripod kit 100 is used by placing each spike 30 of each spike-tripod 100 within an existing aperture 200a of an aftermarket auto part 200. Each existing aperture 200a is pre-designed to secure to another existing auto part when placed on a vehicle. Most auto parts painted will require at least two spike-tripods 100 to secure them in a position that will allow the auto part 200 to be painted.

An advantage of the present invention is that it provides a spike-tripod kit that allows a paint technician to paint an aftermarket part without having to manipulate it from one location to another.

Another advantage of the present invention is that it provides a spike-tripod kit that will not move when painting an aftermarket part.

Yet another advantage of the present invention is that it provides a spike tripod-kit that reduces the time needed to paint an aftermarket auto parts.

Still a further advantage of the present invention is that it provides a spike-tripod kit that can be stored in small spaces.

Yet still a further advantage of the present invention is that it provides a spike-tripod kit that is used to paint auto parts having different dimensions.

Yet still another advantage of the present invention is that it provides a spike-tripod kit minimizes the chances of inadvertently contaminating the surface of an auto part being painted.

While the inventor's above description contains many specificities, these should not be construed as limitations on the scope, but rather as an exemplification of several preferred embodiments thereof. Accordingly, the scope should not be determined by the embodiments illustrated, but by the appended claims and their legal equivalents.

What is claimed is:

1. A spike-tripod kit used to secure and paint an aftermarket auto part, the spike-tripod kit comprises:
at least one tripod, each tripod defines a stabilizer and an apex point; and
at least one spike, each spike attaches to each apex point.

2. The spike-tripod kit used to secure and paint an aftermarket auto part of claim 1, comprising a plurality of leg extensions, each leg extension attaches to each leg of each tripod.

3. The spike-tripod kit used to secure and paint an aftermarket auto part of claim 2, wherein the tripods are made of metal.

4. The spike-tripod kit used to secure and paint an aftermarket auto part of claim 3, wherein each leg measures at least 3 feet and each spike measures at least 2.5 inches.

5. The spike-tripod kit used to secure and paint an aftermarket auto part of claim 4, wherein each leg extension can extend from about 1.0 foot to about 3 feet.
